(19) United States
(12) Patent Application Publication
(10) Pub. No.: US 2012/0193386 A1
(43) Pub. Date: Aug. 2, 2012

(54) Pac-a-poo

(76) Inventor: Kelley A. McFarland, Rochester, NY (US)

(21) Appl. No.: 12/931,365

(22) Filed: Jan. 31, 2011

(51) Int. Cl. A01K 29/00

(52) U.S. Cl. 224/666

(57) ABSTRACT

My invention, Pac-a-poo, is a unisex bag that temporarily holds dog-waste in a secure sanitary place; it provides a dispenser compartment for disposable waste bags, it has extra outer storage for accessories such as gloves, a flashlight, tissues, a cell phone and any other accessories.

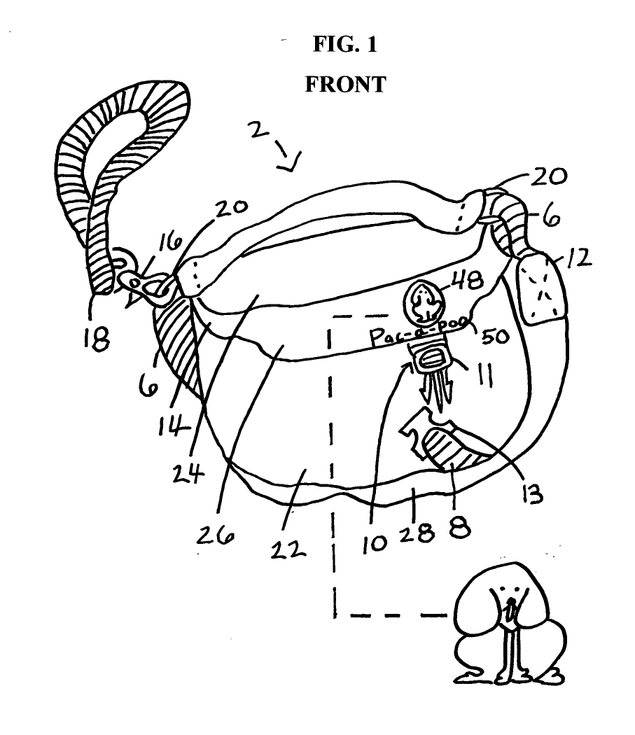

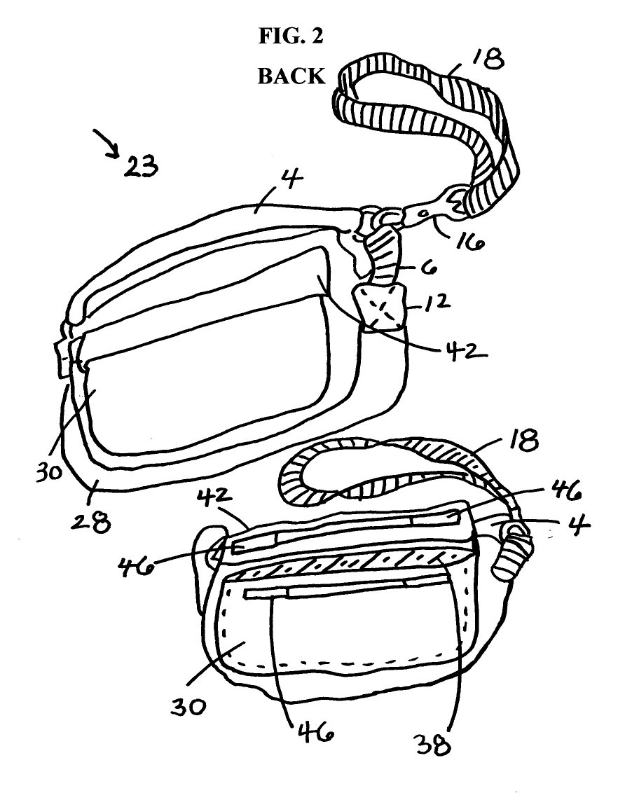

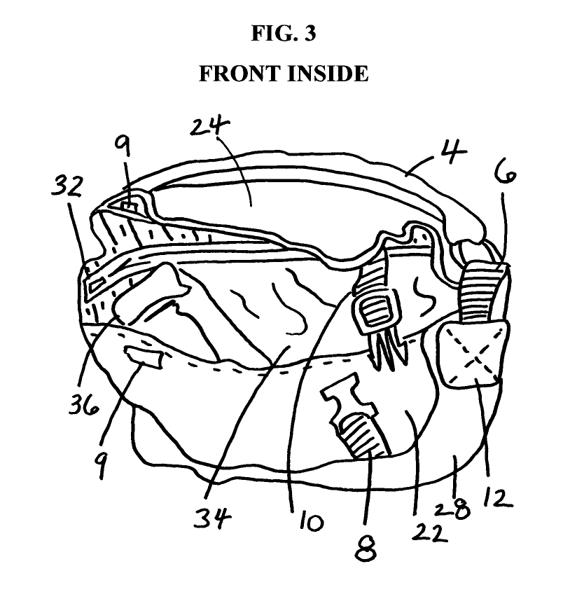

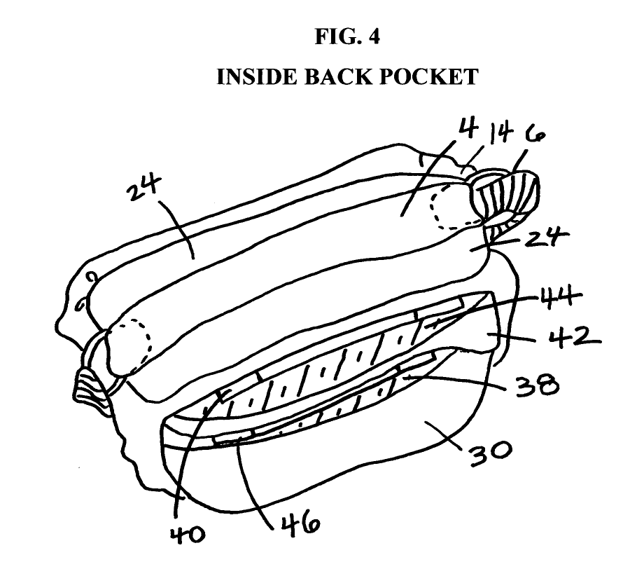

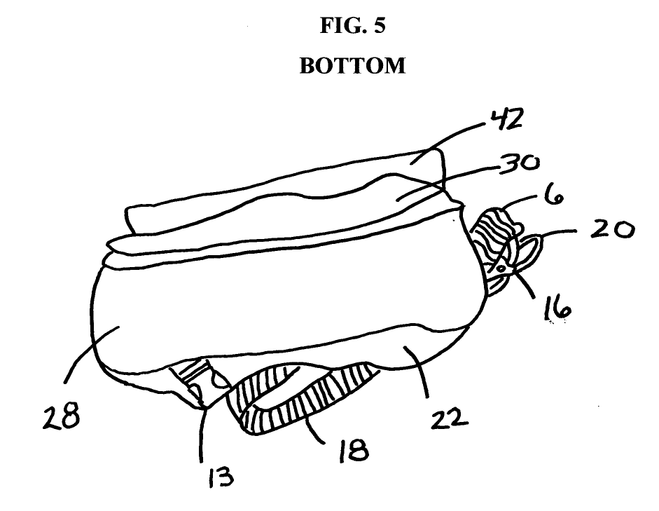

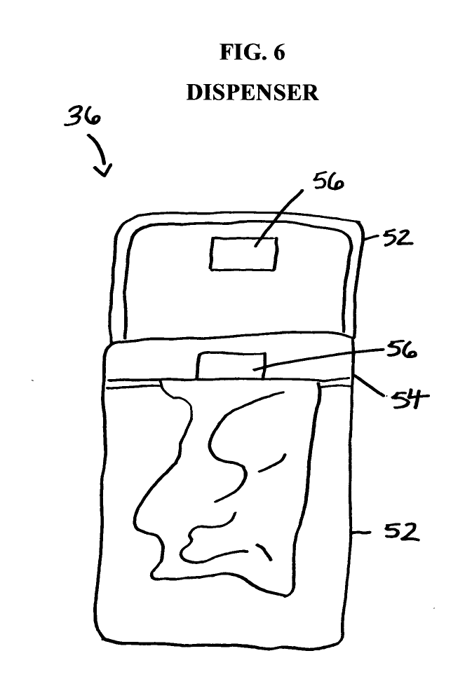

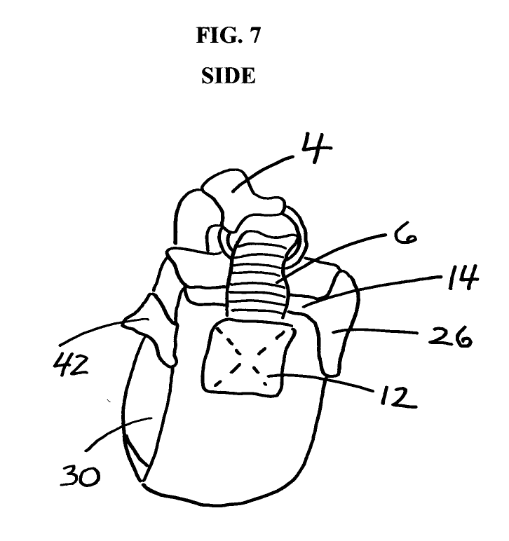

### BRIEF DESCRIPTION OF INVENTION

A bag with multiple compartments, one for disposable bags, two for accessories such as cell phone, gloves, flashlight, and a main one for holding waste-containing bags as well as a small pouch which holds disposable bags.

### THE PROBLEM THE INVENTION SOLVES

When people are walking their dogs, they typically don't have a convenient storage to hide waste and to hold their needed accessories such as cell phones, gloves, etc., and a sanitary separate storage facility to keep waste storage out of direct contact with them.

### HOW THE INVENTION SOLVES THE PROBLEM

My invention “Pac-a-poo” is a bag which provides an attractive and convenient design which offers storage for waste-containing bags, a space for a disposable bag dispenser and other compartments for holding needed accessories such as cell phones, gloves, hand sanitizer, small flashlight, etc.

### MY INVENTION IS AN IMPROVEMENT OVER WHAT CURRENTLY EXISTS

My invention which is not an improvement but a new product offers protection from unsanitary bags while at the same time provides extra space for accessory items. And is offered with a convenient detachable wrist strap for ease of handling and washing of the bag.

### PARTS OR COMPONENTS OF THE INVENTION

Please refer to the drawings at the end of this example for a key to the reference numbers.

| Reference Number | Name of Part |
|---|---|
| 2 | Bag |
| 3 | Lining |
| 4 | Top Handle |
| 6 | Permanent Strap |
| 8 | Bottom part of Connecting Strap |
| 9 | Small Velcro strip |
| 10 | Top part of connecting strap |
| 11 | Top part of 3-prong hook |
| 12 | Reinforcement fabric with X-stitching |
| 13 | Bottom part of clip |
| 14 | Side of top enclosure |
| 16 | Swivel locking hook |
| 18 | Wrist strap |
| 20 | O-ring |
| 22 | Front of bag |
| 23 | Back of bag |
| 24 | Top of bag enclosure flap |
| 26 | Front of bag enclosure flap |
| 28 | Bottom of bag and sides |
| 30 | Back pocket |
| 32 | Zipper of plastic pouch |
| 34 | Plastic pouch |
| 36 | Dispenser for plastic disposable bags |
| 38 | Inside of back pocket |
| 40 | Velcro strip |
| 42 | Front flap of back pocket |
| 44 | Space behind back pocket |
| 46 | Velcro strip for outer pocket |
| 48 | Pac-a-poo emblem |
| 50 | Pac-a-poo wording |
| 52 | Pouch for disposable roll |
| 54 | Lip for disposable pouch |
| 56 | Small Velcro strip |

The bag 2 is a device configured and designed to allow a human person to carry dog waste disposable bags, waste-containing bags and accessories such as cell phones, gloves, flash light and any other small items. The bag 2 may be made of any type of material, of any weight, preferably of a more durable weight so long as it is washable or spot cleanable. The size of bag 2 may be between 8″ and 12″ long, 6½ and 7½ inches deep and between 3½ and 5½ inches wide. The shape of the bag 2 is curved on the bottom for ease of placement for waste-containing bags. The bottom contours are smooth enough for easy cleaning.

The inside of bag 2 has a lining 3 which has the same dimensions as the outside of bag 2. The material may or may not be of the same fabric as the outer part. The shape is contoured along the same dimensions of bag 2.

The top handle 4 may or may not be made of the same fabric as the bag 2. It is designed and configured for any size human hand to grasp with ease and comfort. The shape of the top handle 4 may be a flat long strip or al cylindrical handle with flat ends connecting to the top of bag 2. The size of top handle 4 may be between 8 and 12 inches long. The stitching at both ends of the top handle 4 may be either straight (perpendicular) to top handle 4, or crossed.

The permanent strap 6 with O-ring 20 is designed and configured and connecting the O-ring to the end of the top handle 4 to allow for the wrist strap 18 to be attached to it by the swivel hook 16. The material may or may not be made of leash nylon for strength, durability and of various designs. The permanent strap 6 is connected to the side 28 of bag 2 with reinforcement fabric with x-stitching 12. The permanent straps 6 may comprise but not limited to leash nylon fabric and may be between 5 to 6 inches long looped into O-ring 20 of which is then connected to wrist strap 18.

The wrist strap 18 may or may not be made of the same fabric as the bag 2 but preferably made out of heavy nylon leash material that matches the permanent straps 6. The length of the wrist strap 18 has a perimeter opening between 11 and 12 inches. The wrist strap 18 is connected to one end of swivel locking-hook 16 which makes it detachable from the bag 2.

The O-ring 20 is designed and configured to hold the permanent straps 6 and the top handle 4. The material may comprise of any hard material including but not limited to metal and plastic. The shape is round and the size may have a diameter between ½ to 1 inch.

The top of bag enclosure flap 24 of bag 2 is designed and configured to completely cover the top of bag 2. The material of the top 24 of bag 2 may be made of the same material as the rest of the bag 2. The shape of top 24 is preferably slightly curved to ease closure but could take on any other shape such as square or rectangular. The size of top 24 of bag 2 may be between 8 and 12 inches.

The front of bag front 22 is designed and configured to allow enough room for waste disposable bags and waste-containing bags. The material may comprise any type of fabric including but not limited to cotton, nylon or a mixture of the two or different types of durable fabric or their combinations. The shape of bag 22 is preferably a rounded-rectangular shape but could take any other shape such as square or triangular. It is to preferably have a measurement between 8½ to 12 inches long and 6 to 7½ inches deep.

The front of bag enclosure flap 26 is designed and configured to help keep moisture out and contents of bag from being exposed. The material may comprise any type of fabric including but not limited to cotton, nylon or a mixture of different durable materials. The shape of 26 is preferably a rounded rectangular shape but could take on other shapes such as a regular rectangle or any other stylized front. It may comprise of a small piece of Velcro 9 on the underside and to the left of flap 26 and the other half of Velcro 9 on the front 22 of the bag 2.

The bottom and sides 28 of bag 2 are designed and configured to keep contents in bag and also allowing enough room for them. The strip 28 is sewn to the front of bag 22 and back of bag 23 to secure it in place. The material may comprise any type of fabric including but not limited to cotton, nylon, or a mixture of any other washable durable fabric. The shape of bottom of bag and sides 28 is a long strip of fabric sewn to the front of bag 22 and the back of bag 23. The long strip of fabric 28 may have a measurement between 4.2 inches and 5.2 inches wide and 24 inches and 28 inches long.

The back pocket 30 is designed and configured to help to add more room to bag 2 construction and is also large enough to allow enough room to support any contents such as cell phones, gloves, small flashlight, etc. The material may comprise of the same material as bag 2. It may or may not be limited to cotton, nylon, or any other mixture of fibers that are washable. The shape of back pocket 30 may or may not be rectangular with curved edges on the bottom. It could be also perfectly rectangular. The size of back pocket 30 may be between 6½ and 10½ inches long ad 4½ and 5½ inches deep.

The zipper of plastic pouch 32 is designed to open and close to put contents in and take contents out. The material may comprise any kind of material including but not limited to cotton, nylon or a mixture of the two. The shape of the zipper is of a long strip with closure rasp located on the left and opening towards the right. The size of the zipper may be between 6 and 10 inches long.

The plastic pouch 34 is designed and configured to hold waste-containing disposable bags. The plastic pouch 34 may comprise of any type of plastic including but not limited to flexible higher gauge flexible plastic. The plastic may or may not be impregnated with any type of scent and may or may not be of anti-microbial plastic. The shape of plastic pouch 34 may be but not limited to a rectangular shape. It could include a rectangular shape with curved edges at the bottom. The size of the plastic pouch 34 may be between 6 and 10 inches long and 5 and 6 inches deep. The plastic pouch 34 also has a strip of velcro between 1½ to 6 inches long so that it can attach to the inside of bag 2.

The dispenser for plastic disposable bags 36 is designed and configured to hold standard rolls of disposable bags. The material of 36 may comprise of but not limited to cotton, nylon, or any other combination of durable washable fabric. The shape of the dispenser 36 is of a rectangular shape but not limited to a rectangular shape. It may be of a more rounded rectangular shape more contoured to fit the rolls. The size of 36 may be between 3 and 3½ inches wide and 4½ to 5½ inches deep. If it is of a rounded rectangular shape at the bottom it may be between 3 and 3½ inches wide and 4½ to 5½ inches deep.

The inside of back pocket 38 is designed and configured to make room to support and contents such as a cell phone, gloves, a small flashlight and any other small items. The material may comprise of the same material as bag 2. It may not be limited to cotton, nylon, or any other material of fibers that are washable. The shape of back pocket 38 may not be limited to a shape of a rectangle. It may take on the shape of a rectangle with rounded edges on the bottom. The size of the inside of back pocket 38 may be between 6 to 10½ inches long and 4½ and 5½ inches deep. The inside of back pocket 38 may have one side of Velcro strip 40 not limited to be between 6 and 7½ inches long on the back side of the inside of the pocket 38 and 6 and 7½ inches long attached to the outer side that has front flap 42. The front flap of back pocket 42 is designed to add a finished look to the back pocket 38. The fabric is doubled with right sides together and sewn, then turned out to create a finished look when the pocket flap is flipped up. The front flap of back pocket 42 is configured to secure any contents added to back pocket 38. Inside of flap of back pocket 42 may contain a Velcro strip 46 between 6 and 7 inches long and the mate of Velcro strip 46, between 6 and 7 inches long on the outside of back pocket 38.

The inside space behind back pocket 44 is an extra area designed and configured to hold small foldable items such as tissues, gloves, etc. It may comprise but not limited to a Velcro strip between 6 and 8 inches on both sides of it's opening. The material may comprise of cotton, nylon, or a mixture of them or other fibers and other mixtures of fibers that are washable. The shape of the inside space is within the same measurements of the back pocket 38. The size of the space is within the same measurements of back pocket 38.

The Pac-a-poo emblem 48 is stitched onto the outer flap 26 to identify the name of bag 2. It may comprise of but not limited to nylon stitching, cotton stitching or a thread containing a combination of durable fibers. It is a picture of a dog sitting down facing forward with a tongue hanging out. It has two round black eyes, a round black nose with droopy jaws on either side, two long floppy ears hanging to it's hind legs of which are quite large and rounded. It has two skinny long two front legs in front and all four feet are turned out. The color of the dog may comprise but not limited to the color white and the background preferably but not limited to the color of navy blue. The shape of the emblem 48 may comprise but not limited to an oval design. It could be square, rectangular or triangular measuring ½ to 1½ inches in length and ¼ to ½ inches in width.

The letters of 50 may comprise but not limited to cotton, nylon or a mixture of fibers. The stitching may be stitched directly onto flap 26. The size of the Pac-a-poo name 50 may be between 1¼ to 2 inches in length and it may be but not limited to a Times-Roman style.

The pouch for disposable rolls 52 is designed and configured to hold two or more standard dog waste disposable plastic rolls of plastic bags. The material may comprise but not limited to cotton, nylon, a combination of the two or any other material or combinations of material that are durable and washable. The shape of the disposable bag pouch 52 is between 4½ to 5½ inches long and 3 to 3½ inches wide. The shape of 52 may comprise of a rectangular shape and also may be square in shape measuring 3½ by 3½ inches square.

The lip 54 for pouch 52 is designed and configured to be an upper part of the opening that allows for a plastic sheet of the plastic roll of bags to be pulled through and torn at the perforation when pressure is exerted against the upper lip 54 or may be drawn down the bottom part of the disposable pouch 52. The perforation may be but not limited to an opening similar to a narrow buttonhole reinforced with stitching.

The embodiments of the invention in which an exclusive property or privilege is claimed are defined as follows:

1. A unisex bag with a detachable wrist strap held by a swivel hook, with a built-in dispenser for disposable bags, that temporarily holds dog waste in a secure and sanitary place while at the same time providing storage for flashlights, gloves, cell phones, hand sanitizers, tissues, and other items.
